(19) United States
(12) Patent Application Publication
(10) Pub. No.: US 2013/0298797 A1
(43) Pub. Date: Nov. 14, 2013

(54) LIQUID PERMANENT PROTECTIVE BARRIER FOR TRAFFIC SIGN FACES

(71) Applicant: PAUL RICHARD SCHMERSEY, Keller, TX (US)

(72) Inventor: PAUL RICHARD SCHMERSEY, Keller, TX (US)

(73) Assignee: PAUL RICHARD SCHMERSEY, Keller, TX (US)

(21) Appl. No.: 13/471,089

(22) Filed: May 14, 2012

(51) Int. Cl. C09D 5/00

(52) U.S. Cl. 106/2

(57) ABSTRACT

This disclosure describes a new liquid product that, when applied to a traffic sign face or other surfaces will protect that surface from damage caused by graffiti, weather, stickers, salt air and other contaminants. When surfaces that have been treated with this invention, most all damage can be prevented eliminating millions of dollars in savings per year and also providing life saving features to motorist because of the added protection to traffic sign faces. Other products, such as film laminates must be applied using special equipment in sign shops but with this invention, the protective barrier can be applied using simple paint rollers to signs in service along the roadway that are in vertical position and keeping the sign within federal standards.

### BACKGROUND OF THE INVENTION

Each year, more than 2 billion dollars are spent nationwide to control graffiti. Previously, no product has been available to prevent graffiti or the damage done to the surfaces tagged with graffiti. Each year signs, especially highway traffic signs are replaced because of graffiti damage. Graffiti cannot be removed from sign faces without causing damage that results in requiring complete replacement of the sign. Each year, signs have to be replaced because of fading and discoloration caused by ultraviolet rays. Each year surfaces have to be cleaned and recoated because of environmental or other contaminants collecting on these surfaces. Each year, buildings require that graffiti be removed and then be repainted as the graffiti paint cannot be removed without damaging the original surface paint.

### PAST AND CURRENT ART

The current method of protecting sign faces, or other surfaces, from graffiti or other unwanted or damaging contaminants their surface is first, to apply a film product to the surface using special equipment. This application method requires the surface to be protected must be in a specialized shop that has the required equipment to apply the product. Once the film is applied, it must be cut and trimmed to match the edges of the treated surface. This trimming results in exposed edges which can lead to delaminating of the film. It also results in excessive product cost because of the cutting and trimming and wasted film. In protective coatings used on other surfaces than traffic signs, the coatings are removed at the time of removing the contaminants and the protective coating must be reapplied. In the case of traffic signs, the removal of graffiti or contaminants can only be done two to three times before the film is no longer serviceable and a new layer of film cannot be applied over the old layer and the sign face must be replaced.

### BRIEF SUMMARY OF THE INVENTION

This invention eliminates each and every negative feature of the past and current art. With this new invention, traffic signs and other surfaces can now be protected and reduce, by as much as 90%, the costs currently being spent to clean, recoat or replace the surfaces affected by graffiti, ultraviolet rays and other contaminants applied to or collected on these surfaces. This invention is a liquid permanent protective barrier coating that can be applied to traffic sign faces and most all other surfaces needing protection from graffiti, ultraviolet rays and most other contaminants that would cause damage, fading, changes in appearance or reduction in reflectivity that would result in the surface failing to meet the required qualities and specifications making it mandatory that the surfaces be repaired, repainted or replaced at a very high cost.

This invention, a liquid permanent protective barrier coating can be applied by airless spray systems or by simple paint roller. The application of this invention, the liquid permanent protective barrier, can be accomplished indoors or outdoors. The invention can be applied to vertical or horizontal surfaces areas. This permanent protective barrier coating becomes solid within hours but remains completely flexible. This invention can be applied to porous and non porous surfaces, rough or smooth surfaces and to surfaces requiring reflective qualities and stability of color retention, color contrast, and color appearance. When a surface that is treated with this invention, the liquid permanent protective barrier coating, and then gets any contaminants on it, most all contaminants can be sprayed with a compatible barrier cleaner and wiped clean leaving the permanent protective barrier in place and without any harm or reduction in the protective qualities.

This invention has been laboratory tested as well as field tested by a number of State Highway Departments, their Sign Divisions and also a large number of City Departments of Public Works. When this new invention was applied to a traffic sign face and laboratory tested according to the FHWA Standards and MUTCD minimum standards for reflective sheeting products, the results were the sign faces remained in compliance to the Federal Standards for all grades of sheeting products and for all tested qualities such as reflectivity, color retention, daytime color appearance. The test procedures set out by Federal Standards were ASTM tests E808, E809, E810, E1709,and ASTM D4956. When tested according to MSDS weatherometer, the results were after 8800 hours of testing, the barrier had lost less than 1% of the protective qualities.

When this invention was tested in the field, the results were a complete success. Sign faces that had been tagged with graffiti were no longer serviceable and required replacement but the signs that had been treated with this invention, a liquid permanent protective barrier, were tagged with graffiti were able to be cleaned without any damage and without any reduction in quality and remained in service.

### SUMMARY OF BENEFITS OF THIS INVENTION

With this new invention, the use of the liquid permanent protective barrier coating on surfaces such as traffic signs, this new invention will provide the follow benefits:

1. As MUCH AS 40% LONGER LIFE.

2. AS MUCH AS 88% CHEAPER THAN A FILM APPLICATION PROTECTIVE PRODUCT.

3. NO DAMAGE TO EXISTING SIGN FACES.

4. EASE OF APPLICATION.

5. NO SPECIAL EQUIPMENT REQUIRED FOR APPLYING THE PRODUCT.

6. MUCH FASTER TO APPLY THAT FILM PROTECTORS.

7. CAN BE APPLIED TO SIGNS IN SERVICE WITHOUT REMOVAL.

8. NO REQUIRED CUTTING OR TRIMMING AS FILMS REQUIRE.

9. GRAFFITI OR OTHER CONTAMINENTS CAN BE REMOVED UNLIMITED TIMES WITHOUT DAMAGE TO THE PROTECTIVE BARRIER.

10. SIGN REFLECTIVITY WILL STILL REMAIN ABOVE FHWA REQUIREMENTS.

11. SIGN COLOR APPEARANCE AND CONTRACT REMAIN ABOVE FHWA REQUIREMENTS.

1. This invention is a liquid that when applied to a traffic sign face, it will seal the cut edges of the sign face and aid in protection of the sign face delaminating. The invention will also increase protection against ultraviolet rays that damage sign faces. When traffic sign faces have been treated with this invention, surface contaminations, such as graffiti, stickers, tree sap can be cleaned from the traffic sign by using a compatible cleaner eliminating expensive sign replacement and the labor required to replace the sign. After cleaning a traffic sign that has been treated with this invention, the invention remains in full service and can be cleaned repeated times without damage to this invention or the sign face itself. Use of this invention will not cause damage to appearance, the color contrast or the Reflectivity of a traffic sign face. Application of this invention can be easily accomplished using a high density foam roller or airless sprayer and it can be applied to the traffic sign surface in either a horizontal or vertical position. This invention can also be used on any type surface as well as traffic sign faces.
